(19) United States
(12) Patent Application Publication
(10) Pub. No.: US 2009/0289451 A1
(43) Pub. Date: Nov. 26, 2009

(54) T-Nut Assembly For Sealing An Existing Connection In A Lined Conduit

(75) Inventors: Keith B. Oxner, Chesterfield, MA (US); Richard C. Polivka, Lemont, IL (US); Stephen B. Heuiser, Manchester, MO (US); Neil T. Birchler, St. Peters, MO (US)

Correspondence Address: MCCARTER & ENGLISH, LLP STAMFORD, FINANCIAL CENTRE , SUITE 304A, 695 EAST MAIN STREET, STAMFORD, CT, 06901-2138, US

(73) Assignee: INA Acquisition Corp., Wilmington, DE (US)

(21) Appl. No.: 12/468,455

(22) Filed: May 19, 2009

Related U.S. Application Data
(60) Provisional application No. 61/054,889, filed on May 21, 2008.

(51) Int. Cl. F16L 41/00

(52) U.S. Cl. 285/189

(57) ABSTRACT

A T-nut assembly for reinstating a sealed connection in a lined conduit is provided. The assembly includes a rigid T-nut having a hollow tubular region with an engagement surface at one end and a base with an opening therethrough at the other. The base has a larger diameter than the tubular region. The T-nut includes an integral shoulder around the tubular member at the base and has a larger diameter than the tubular region and less than the base. The outside of the shoulder has a wall extending above the shoulder to form an annular recess at the engagement end. A substantially rigid sealing washer is placed in the annular recess and a compressible gasket is placed on the base about the shoulder.

### CROSS REFERENCE TO RELATED APPLICATIONS

This application is based on and claims the benefit of provisional application No. 61/054,889 filed May 21, 2008.

### BACKGROUND OF THE INVENTION

This invention relates to a device for reinstating a connection in a lined conduit and more particularly to an improved T-nut for use in the reinstatement.

A variety of circumstances exist in which it is desirable to form a junction or branch line from a main, fluid-carrying conduit. For instance, in the municipal area, it is often necessary to install a branch line into a water main, gas main or sewer main. A similar need exists in other industries, such as in the chemical pipeline industries.

In the municipal area, many water mains were constructed years ago and the wall structures are now badly eroded or collapsing. In order to repair such damage, it has been proposed to install a liner within these lines to provide a new water-impervious wall to the system. There are a wide variety of different methods available in the art for inserting liners within existing conduits. These lining methods include the cured-in-place, fold-and-form and diameter reduction methods, each of which inserts a liner from one end of the conduit to the other. However, the wall of the liner is usually not continuous since branch lines and service connections intersect the main conduit at various entry ports to allow the free flow of fluid from the main to the branch service line. In the case of existing and newly formed entry ports, it is desirable to utilize a corporation stop at the junction to control the fluid on either a temporary or a permanent basis. In connection with the corporation stop, a T-nut is used to make a sealed connection from the liner to the conduit.

It is desirable to reinstate the connection internally after the lining operation. To be successful, the reinstatement must form a seal between the reconnection member and the lining and between the reconnection member and the branch or service connection.

An example of an internal tap being installed from the inside of the conduit is disclosed in U.S. application Ser. No. 11/796,379 filed on Apr. 27, 2007. This discloses a method and apparatus for internal tapping of a lined conduit by forming at least one opening in the liner where a corporation stop protrudes into the conduit and inserting a T-nut having a tubular threaded section and a base with a sealing donut and compressible gasket facing the liner to form a pressure tight seal. The T-nut may be self threading or an internal thread can be first formed in the inner bore before inserting a threaded T-nut. The T-nut assembly is installed using a robot or lateral cutter with a rotating turntable for driving and rotating the T-nut into the interior of the corporation stop.

These prior art T-nut devices form an acceptable seal during internal reinstatement of a connection in a lined conduit. However, it is desirable to provide an improved seal at an internal connection in the lined conduit.

### SUMMARY OF THE INVENTION

Generally speaking, in accordance with the invention, an improved T-nut assembly including a T-nut with shoulder for use in the internal reinstatement of a connection in a lined conduit and forming a seal is provided. The T-nut assembly includes a T-nut having a hollow tubular section at a first connection end with an engaging surface and a base of a larger diameter at the other end thereof. A shoulder around the tubular section at the base has a larger diameter than the connection end, but is smaller than the base and has an annular recess at the engagement end of the shoulder. An outside wall of the shoulder extends beyond the shoulder to form the annular recess about the tubular engagement section. A compressible gasket is placed about the shoulder and base extending to just above the height of the shoulder and a substantially rigid sealing washer is disposed in the annular recess of the shoulder just above the height of the gasket.

Generally the exiting conduit is prepared by milling any existing connection that extends into the conduit. The existing conduit is then lined, the connection is located and a hole is cut in the liner. A T-nut is inserted from the conduit into the existing service connection and fully engaged. The liner is pushed by the gasket against the existing conduit and the sealing washer is urged against the edge of the existing connector.

Accordingly, it is an object of the invention to provide an assembly to engage a connection when reinstating service in a lined conduit.

Another object of the invention is to provide a device for sealing the reinstalled connection.

Yet another object of the invention is to provide an improved T-nut for providing the seal when reinstating service.

Still other object and advantages of the invention will in part be obvious and will in part be apparent from the specification.

The invention comprises a product possessing the features, properties, and the relation of components which will be exemplified in the product hereinafter described and the scope of the invention will be indicated in the claims.

### BRIEF DESCRIPTION OF THE DRAWINGS

For a fuller understanding of the invention, reference is had to the following description taken in connection with the accompanying drawings in which:

FIG. 1 is a perspective view of a segment of a fluid-carrying conduit with an installed corporation stop in a lined conduit;

FIG. 2 is a partial cross-section view of the lined fluid-carrying conduit of FIG. 1 showing a milled corporation stop;

FIG. 3 is a perspective view of an improved self-tapping T-nut to be used in an improved T-nut assembly constructed and arranged in accordance with the invention;

FIG. 4 is a perspective view of the T-nut of FIG. 3 with a sealing washer in the annular recess;

FIG. 5 is a perspective view of a T-nut assembly in accordance with the invention;

FIG. 6 is a perspective view of a T-nut assembly similar to that of FIG. 5 and having a T-nut with a round base with a sealing gasket in place; and

FIG. 7 is a cross-sectional view showing a T-nut assembly installed in a lined conduit in accordance with the invention.

### DESCRIPTION OF THE PREFERRED EMBODIMENTS

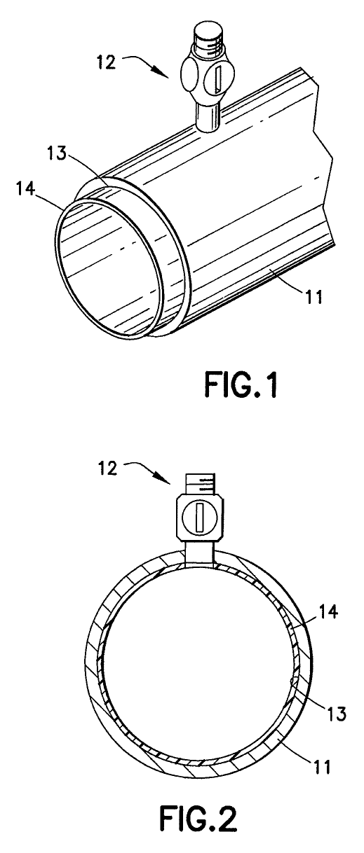

FIG. 1 shows a longitudinally extending host conduit 11, such as a water main, gas main, sewer pipe, or the like with an installed corporation stop 12. Conduit 11 is a steel pipe and has a generally cylindrical interior sidewall 13 which has been lined with a synthetic liner 14 formed from a cured in place liner or polyolefin, e.g. polyethylene or other similar synthetic lining system.

A well-known process for rehabilitation of existing conduits generally utilizing a flexible liner to be cured in place is the “Insituform®” method described in U.S. Pat. Nos. 4,009,063 and 4,064,211, the contents of which are incorporated herein by reference in its entirety. Another rehabilitation process known as the “NuPipe®” process is described in U.S. Pat. No. 4,867,921 and U.S. Pat. No. 5,255,624, the contents of which are incorporated here by reference in its entirety. In this latter process a substantially rigid replacement pipe is installed in a flattened and folded shape, heated and expanded to the shape of the original conduit. Another process for lining conduits familiar to those skilled in the art is diameter reduction, which is described in U.S. Pat. No. 4,923,663, issued to McMillan, the content of which is incorporated by reference in its entirety. Another pipe lining and process is discussed in U.S. Pat. No. 5,934,332 to Rodriguez et al., the content of which is incorporated herein by reference in its entirety. This later pipe lining is used in the examples shown herein in the drawings.

FIG. 2 shows a partial cross-section view of conduit 11 showing liner 14 installed in conduit 11 with corporation stop 12 that has been milled to remove the portion that protrudes into the interior of conduit 11 prior to lining. After lining conduit 11, corporation 12 is located and a hole is formed in liner 14. A T-nut or fitting is to be inserted into corporation 12 to reinstate the connection to conduit 11.

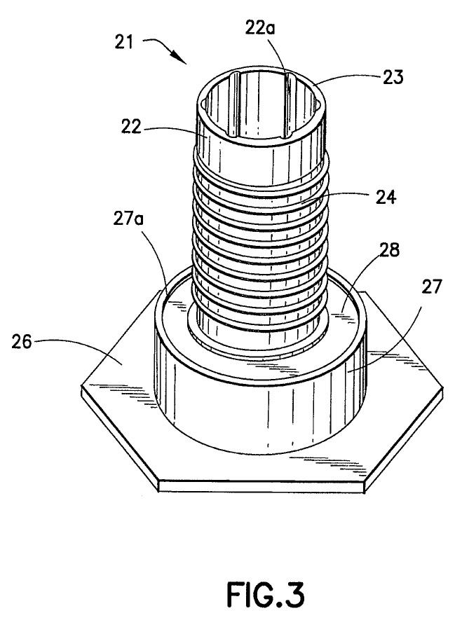

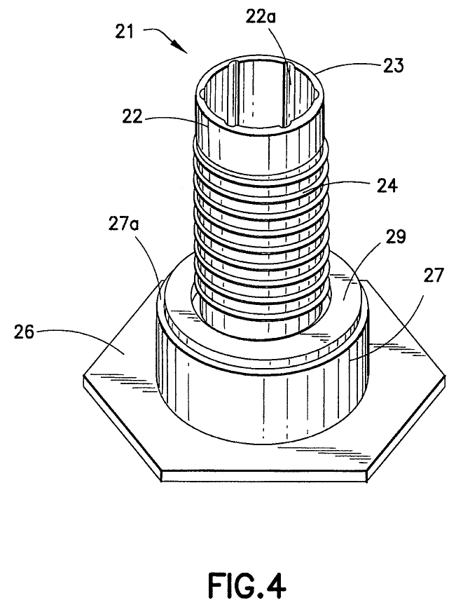

FIG. 3 shows a T-nut 21 with an integral shoulder constructed and arranged in accordance with the invention to be inserted into corporation stop 12 in a lined conduit 11. T-nut 21 has a tubular portion 22 with a pilot end 23 and a left-handed self-threading region 24 connected to a base 26 at the other end. A shoulder 27 having a diameter greater than threaded portion 24 is formed at base 26. Shoulder 27 has an outer wall 27a that extends to a height above the interior portion to form an annular recess 28. A sealing washer 29 as shown on FIG. 4 is seated in annular recess 28. In this embodiment, shoulder is integrally formed with tubular portion 22 and base 26.

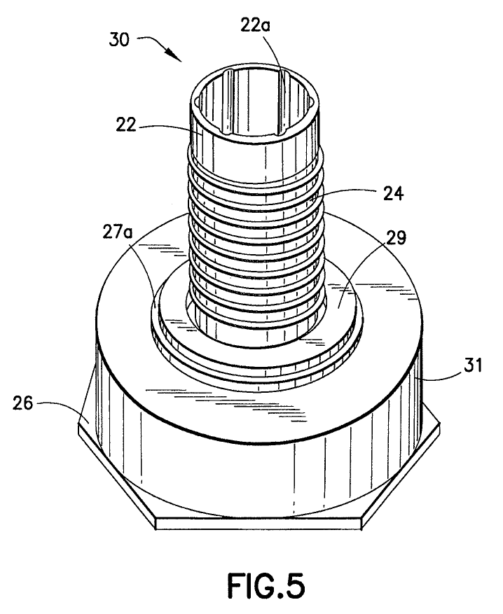

Sealing washer 29 may be formed of any suitable engineering plastic substantially rigid, such as nylon or polyethylene. Preferably, sealing washer 29 is made of low density polyethylene, or other suitable engineering plastic, such as nylon. As shown in FIG. 5 a compressible gasket 31 is placed on base 26 around integral shoulder 27 to complete a T-nut assembly 30 to be ready for installation. Gasket 31 may be an EPDM rubber or other suitable compressible synthetic material. Once gasket 31 and washer 29 are installed, T-nut assembly 30 for forming a seal at the connection is complete. Sealing gasket 31 extends to a height about equal to or slightly taller than outer wall 27a. When seated in annular groove 28, sealing washer 29 extends to about the height of, or slightly higher than the height of the top of outer wall 27a.

After conduit 11 has been lined, an opening 16 having a diameter slightly larger than the diameter of shoulder 27 is cut in liner 14. T-nut assembly 30 is then inserted into opening 16 in liner 14 and T-nut 21 is screwed into the central bore of corporation 12. This operation of location, cutting and inserting a T-nut into corporation 12 is fully described in copending application Ser. No. 11/796,379, the content of which is incorporated herein in its entirety. As sealing washer 29 approaches the base of corporation 12, sealing gasket 31 is compressed between base 26 and liner 14. This also urges liner 14 against interior wall 13 of conduit 11. As threads 24 are fully engaged within corporation 11, sealing washer 29 is deformed slightly and a sealed connection is formed. Shoulder 27 and washer 29 insure that threads 24 are screwed into corporation 12 the correct distance.

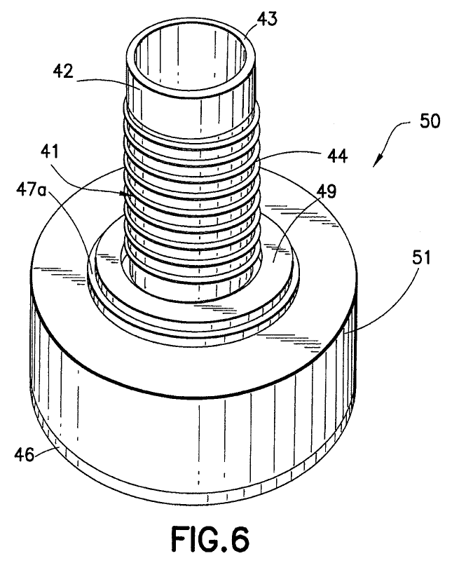

FIG. 6 illustrates another T-nut assembly 50 constructed and arranged in accordance with the invention having a round base 46. Assembly 50 includes a T-nut 41 with a tubular section 42 and a pilot end 43. This T-nut 41 also has a left-hand self-tapping thread 44 integrally formed with a base 46 and a shoulder with an extending side wall 47a for receiving a sealing gasket 51 and a sealing washer 49.

In most cases the internal bore of T-nuts 21, 41 in accordance with the invention will have a at least a section having a regular geometric shape, such as a square or hexagon to allow use of a corresponding drive or tool to install and remove T-nut 21, 41 from the inside of a conduit. T-nut 21 in FIG. 3 has six slots 22a for receiving a hexagonal tool to aid in removal and repair.

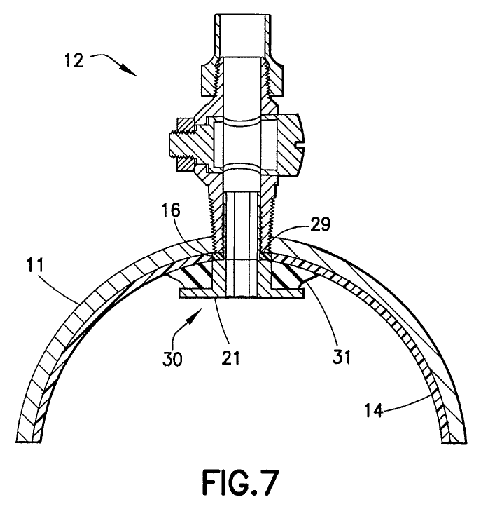

FIG. 7 shows in cross-section an installed T-nut assembly 30 in accordance with the invention. Assembly 30 provides an improved seal at the connection with corporate stop 12 as demonstrated in the following examples.

### EXAMPLE 1

In a first installation 29 connections were reinstated using the T-nut as described in Ser. No. 11/796,379. Of the 29 connections, 6 were found to require repair. This involved digging to replace the connection externally. It is estimated that if a T-nut with a shoulder was used, only two connections would have required repair.

### EXAMPLE 2

In a second installation, 79 connections using a T-nut without a shoulder were reinstalled and 39 required repair. It is estimated that about 10 of these would not have required repair if a T-nut with shoulder was used.

### EXAMPLE 3

In a third test installation using T-nut assembly 30 with T-nut 21 with shoulder 27 and annular groove 28 in accordance with the invention, 23 internal connections were made. All the seals were satisfactory and no excavations were required.

It is believed that the success as illustrated in Example 3 is due to the presence of the rigid shoulder on the T-nut. This is possibly due to the sealing washer in the annular recess of the shoulder. The sealing washer is urged against the end of the corporation stop. This causes the threading to stop and insures that the threaded section has been fully engaged within the bore of the corporation stop. This can easily be determined when the torque on the installation tool or drive records a sharp increase.

While the embodiment described herein utilizes a T-nut with a self-tapping external threaded section, it is within the scope of the invention to reinstate the connection and engage a T-nut into a pre-tapped bore of a corporation stop. This is fully described in application Ser. No. 11/796,379.

It can readily be seen that the process in accordance with the invention readily allows one to conveniently install an internal tap to connect and seal the corporation stop and synthetic liner.

It will thus be seen that the objects set fort above, among those made apparent from the preceding description, are efficiently attained and, since certain changes may be made and carrying out the above method and in the construction set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall there between.

What is claimed is:

1. A T-nut assembly, for use in reestablishing a connection in a lined conduit and forming a seal at the connection, comprising:
a substantially rigid member having a hollow tubular section of a first diameter having a first connection end with an external engagement surface and a base of a second greater diameter at the other end with an opening therethrough;
a shoulder around the tubular member at the base, the shoulder having a greater diameter than the first diameter and less than the diameter of the base and having an outside wall extending beyond the shoulder to form an annular recess about the tubular section;
a substantially rigid sealing washer disposed in the annular recess; and
a compressible gasket on the base about the shoulder extending to the height of the sealing washer.

2. The T-nut assembly of claim 1, wherein the engagement surface is a screw thread.

3. The T-nut assembly of claim 2, wherein the screw thread is a self-tapping thread.

4. The T-nut assembly of claim 2, wherein the screw thread is left handed.

5. The T-nut assembly of claim 1, wherein the opening through the tubular member includes a region having a regular geometric shape for engaging with a corresponding drive or tool.

6. The T-nut assembly of claim 6, wherein the regular geometric shape is hexagonal.

7. The T-nut assembly of claim 1, wherein the first end of the tubular member has a pilot end for punching an opening in a pipe liner.

8. The T-nut assembly of claim 1, wherein the first end of the tubular member has a pilot end fitted with a drill bit for forming an opening in a pipe liner.

9. The T-nut assembly of claim 1, wherein the sealing washer in the recess extends above the wall of the shoulder to a height above same as the gasket.

10. The T-nut assembly of claim 1, wherein the shoulder and outside wall are integrally formed with the tubular section and base.
